(19) United States
(12) Patent Application Publication
(10) Pub. No.: US 2005/0286939 A1
(43) Pub. Date: Dec. 29, 2005

(54) Device for fusing toner on print medium

(75) Inventors: Young-min Chae, Suwon-si (KR); Sang-yong Han, Suwon-si (KR); Joong-gi Kwon, Gunpo-si (KR); Hwan-guem Kim, Seoul (KR); Durk-hyun Cho, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/167,446

(22) Filed: Jun. 28, 2005

Related U.S. Application Data
(60) Provisional application No. 60/583,422, filed on Jun. 29, 2004.

(30) Foreign Application Priority Data
Aug. 21, 2004 (KR) 2004-0066172

(51) Int. Cl. G03G 15/20

(52) U.S. Cl. 399/330

(57) ABSTRACT

Provided is a device for fusing a predetermined toner image on paper, and more particularly, to a device for heating a toner fusing unit by using resistance heating and induction heating simultaneously and fusing a toner image on paper using the heated toner fusing unit. The fusing device comprises an alternating current generator for generating a predetermined alternating current; a coil portion that is resistance-heated by the alternating current and generates an alternating magnetic flux by the alternating current; and a toner fusing unit for generating an eddy current by the alternating magnetic flux and that is induction-heated by the generated eddy current.

### CROSS-REFERENCE TO RELATED PATENT APPLICATIONS

This application claims the benefit under 35 U.S.C. §119(a) of Korean Patent Application No. 10-2004-0066172, filed on Aug. 21, 2004, in the Korean Intellectual Property Office, and the benefit under 35 U.S.C. §119(e) of U.S. Provisional Patent Application No. 60/583,422, filed on Jun. 29, 2004, in the U.S. Patent and Trademark Office, the entire disclosures of which are hereby incorporated by reference.

### BACKGROUND OF THE INVENTION

1. Field of the Invention

The present invention relates to a device for fusing a predetermined toner image on paper. More particularly, the present invention relates to a device in which a toner fusing unit is heated by using resistance heating and induction heating simultaneously and a toner image is fused on paper using the heated toner fusing unit.

2. Description of the Related Art

A conventional image printing apparatus comprises a fusing device which applies a predetermined pressure and amount of heat to a toner so as to fuse a predetermined toner image on paper. The fusing device includes a fusing unit which applies a predetermined amount of heat to the toner and a pressurizer which applies a predetermined pressure to the toner. The fusing unit includes a heating body, which generates heat used to fuse a toner image on the paper, and a fusing roller, which transfers heat generated by the heating body to the paper.

FIG. 1 is a schematic cross-sectional view taken along a lateral plane through a fusing unit 10 of a fusing device using a halogen lamp as a heat source. Referring to FIG. 1, the fusing unit 10 comprises a fusing roller 11 and a heating body 12, which is a halogen lamp, installed in the center of the fusing unit 10. A coating layer 11 a made of Teflon is formed on the surface of the fusing roller 11. The heating body 12 generates heat, and the fusing roller 11 is heated by radiant heat transferred from the heating body 12.

In a conventional fusing unit using a halogen lamp as a heat source, a warm-up time, which is required to reach a target fusing temperature after energy is supplied to fusing unit is from about several seconds to several minutes. Thus, a user potentially has to wait a long time for the printer to warm-up when printing an image.

In the conventional fusing unit using the halogen lamp as the heat source, in order to reduce the warm-up time, the temperature of the fusing roller is maintained above room temperature for a predetermined amount of time even when a printing operation is not performed. Thus, power is consumed unnecessarily.

### SUMMARY OF THE INVENTION

The present invention provides a fusing unit for heating a toner fusing unit by using resistance heating generated in a coil portion and induction heating generated in the toner fusing unit simultaneously.

The present invention also provides a fusing unit in which a coil portion generating an alternating magnetic flux according to a predetermined alternating current and a toner fusing unit that is resistance-heated by an eddy current generated by the variable alternating magnetic flux and that is closely adhered to the coil portion so that the effect of induction heating of the toner fusing unit is maximized.

The present invention also provides a fusing device for heating a toner fusing unit by using resistance heating of a coil portion and induction heating of the toner fusing unit simultaneously.

The present invention also provides a fusing device in which a coil portion generating an alternating magnetic flux according to a predetermined alternating current and a toner fusing unit that is resistance-heated by an eddy current generated by the variable alternating magnetic flux and that is closely adhered to the coil portion so that the effect of induction heating of the toner fusing unit is maximized.

According to an aspect of the present invention, there is provided a unit for fusing a toner on paper, the unit comprising a coil portion that is resistance-heated by a predetermined alternating current and generates an alternating magnetic flux caused by the predetermined alternating current; and a toner fusing unit that is induction-heated by an eddy current generated by the alternating magnetic flux.

According to another aspect of the present invention, there is provided a unit for fusing a toner on paper, the unit comprising a coil portion for generating an alternating magnetic flux by a predetermined alternating current; a toner fusing unit that is induction-heated by an eddy current generated by the alternating magnetic flux; and a tube-expansion adhesion portion closely adhering the coil portion to the toner fusing unit using a predetermined tube-expansion pressure.

According to still another aspect of the present invention, there is provided a device for fusing a toner on paper, the device comprising an alternating current generator for generating a predetermined alternating current; a coil portion that is resistance-heated by the alternating current and generates an alternating magnetic flux caused by the alternating current; and a toner fusing unit that is induction-heated by an eddy current generated by the alternating magnetic flux.

According to yet another aspect of the present invention, there is provided an alternating current generator for generating a predetermined alternating current; a coil portion for generating an alternating magnetic flux caused by the alternating current; a toner fusing unit for generating an eddy current by the alternating magnetic flux and that is induction-heated by the generated eddy current; and a tube-expansion adhesion portion closely adhering the coil portion to the toner fusing unit using a predetermined tube-expansion pressure.

### BRIEF DESCRIPTION OF THE DRAWINGS

The above aspects and advantages of the present invention will become more apparent by describing in detail exemplary embodiments thereof with reference to the attached drawings in which:

FIG. 1 is a schematic cross-sectional view taken along a lateral plane through a conventional fusing unit of a fusing device using a halogen lamp as a heat source;

FIG. 2 is a cross-sectional view taken along a lateral plane through a fusing unit according to an embodiment of the present invention;

FIG. 3 shows an eddy current generated by the toner fusing unit of the fusing unit shown in FIG. 2;

FIG. 4 is a more detailed diagram of a fusing unit according to an embodiment of the present invention;

FIG. 5 is a functional block diagram of a fusing device having the fusing unit shown in FIG. 2, according to an embodiment of the present invention;

FIG. 6 illustrates a heat source for heating the toner fusing unit of the fusing unit of the fusing device according to an embodiment of the present invention;

FIG. 7A is a cross-sectional view taken along a lateral plane through a fusing unit using resistance heating according to an embodiment of the present invention;

FIG. 7B is a cross-sectional view taken along a lateral plane through a fusing unit using induction heating according to an embodiment of the present invention; and

FIG. 8 is a graph of time versus temperature of experimental data comparing a conventional fusing unit to a fusing unit according to embodiments of the present invention.

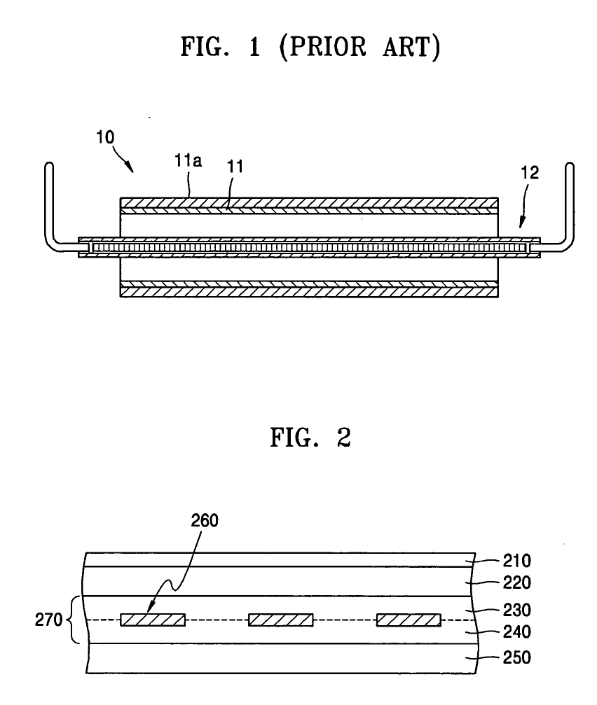

Throughout the drawings, it should be understood that like reference numbers refer to like features, structures and elements.

### DETAILED DESCRIPTION OF EXEMPLARY EMBODIMENTS

FIG. 2 shows an upper side of a cross-sectional view taken along a lateral plane through a cylindrical fusing unit according to an embodiment of the present invention. Referring to FIG. 2, a fusing unit comprises a toner fusing unit 220 in which a protective layer 210 having a surface preferably coated with a non-stick substance, such as Teflon® is formed, a tube-expansion adhesion portion 250 having a tubular shape with open ends disposed inside the toner fusing unit 220, and a coil portion 270 interposed between the toner fusing unit 220 and the tube-expansion adhesion portion 250.

The coil portion 270 comprises a coil 260 and insulating layers 230 and 240. The coil 260 surrounds the tube-expansion adhesion portion 250 in a helical shape. The coil portion 270 is resistance-heated according to its electrical resistance by receiving a predetermined alternating current (AC) supplied by an external power supply unit (not shown).

The coil 260 generates an alternating magnetic flux that changes according to an AC current supplied by the external power supply unit. Owing to the generated alternating magnetic flux, a predetermined eddy current is generated in the toner fusing unit 220. Since the toner fusing unit 220 has electrical resistance, if the generated eddy current flows through the toner fusing unit 220, the toner fusing unit 220 is resistance-heated. Hereinafter, heating of the toner fusing unit 220 using the generated eddy current will be referred to as induction heating. In an embodiment of the present invention, the coil 260 is a ribbon coil made of copper, but a coil made of different materials may also be used as the coil 260 according to an application of fusing device without departing from the scope of the present invention.

The toner fusing unit 220 has characteristics that the toner fusing unit 220 is magnetized by a magnetic field and a predetermined current flows through the toner fusing unit 220. The toner fusing unit 220 may also be formed of a material such as an iron alloy, a copper alloy, an aluminum alloy, a nickel alloy, a magnesium alloy, or a chromium alloy but may be formed of different materials according to the application of the fusing device without departing from the scope of the present invention.

In an exemplary embodiment, the insulating layers 230 and 240 substantially surround the coil 260 and insulate the tube-expansion adhesion portion 250 and the toner fusing unit 220 from the coil 260 so that dielectric breakdown does not occur and a leakage current does not flow through the coil 260 when an alternating current is input to the coil 260. The insulating layers 230 and 240 should have voltage characteristics to withstand typically provided voltages and resistance to dielectric breakdown characteristics required by each of countries where the device is to be used. The withstand voltage characteristics are characteristics which can withstand a predetermined external voltage applied, and the resistance to dielectric breakdown characteristics are characteristics in which 10 mA or greater than leakage current is not generated and dielectric breakdown does not occur within a maximum withstand voltage for one minute. The insulating layers 230 and 240 preferably satisfy withstand voltage characteristics between 3 kV and 6 kV.

The first and second insulating layers 230 and 240 are preferably formed of a material selected from the group consisting of mica, polyimide, ceramic, silicon, polyurethane, glass, and polytetrafluoruethylene (PTFE). Of course, the insulating layers 230 and 240 may be formed of different materials according to the application of the fusing device without departing from the scope of the present invention.

The coil 260 of the coil portion 270 and the first and second insulating layers 230 and 240 are preferably plastic-deformed using a tube-expansion pressure applied by the tube-expansion adhesion portion 250, and the plastic-deformed coil portion 270 is closely adhered to the tube-expansion adhesion portion 250 that may be formed of a nonmagnetic material or a pipe which is not formed in a closed loop. For example, a metallic pipe, a coil spring, formed urethane, or a plastic pipe may be used as the tube-expansion adhesion portion 250.

The tube-expansion pressure applied to the tube-expansion adhesion portion 250 is determined to a degree in which a circumferential tube-expansion pressure of the tube-expansion adhesion portion 250 reaches a yield stress σ of a material used for the tube-expansion adhesion portion 250 and which produces permanent plastic deformation. The tube-expansion pressure P applied to the tube-expansion adhesion portion 250 is determined using Equation 1.

$$P = σ \frac{t}{r} , \qquad Equation ( 1 )$$

where P is the tube-expansion pressure, σ is a yield stress, t is the thickness of the tube-expansion adhesion portion, and r is the radius of a tube-expansion adhesion portion.

In the present embodiment, the coil portion 270 is fixed and closely adhered to the toner fusing unit 220 and is rotated together with the toner fusing unit 220. Thus, an alternating magnetic flux generated in the coil 260 crosses with the toner fusing unit 220 to a maximum extent, and the occurrence of an eddy current is maximized in the toner fusing unit 220. Since the toner fusing unit 220 is heated by using resistance-heating generated in the coil 260 and induction-heat is generated in the toner fusing unit 220 simultaneously, a warm-up time can be reduced.

A fusing roller can be used as the toner fusing unit 220. And, another type of toner fusing unit 220 may be used according to the application of the fusing unit without departing from the scope of the present invention.

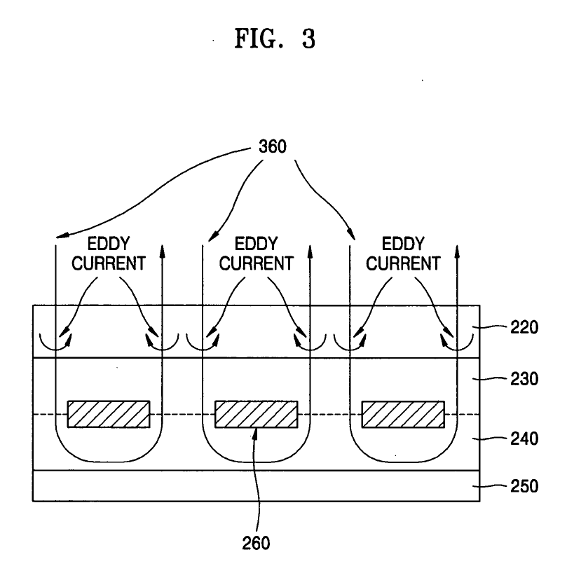

FIG. 3 shows an eddy current generated on the toner fusing unit 220 of the fusing unit shown in FIG. 2. If a predetermined AC current is input to the coil 260 insulated from the toner fusing unit 220 by the insulating layers 230 and 240, an alternating magnetic flux 360 that changes according to the AC current input is generated around the coil 260. The alternating magnetic flux 360 crosses with the toner fusing unit 220. The toner fusing unit 220 generates an eddy current in a direction in which a change of the crossed alternating magnetic flux 360 is disturbed. Here, the generated eddy current is obtained by Equation 2.
We=nₑf²Bₘ² Equation (2)
where nₑ is a constant, f is a frequency of an input AC current, and Bₘ is a magnetic flux density at which an alternating magnetic flux crosses with a toner fusing unit.

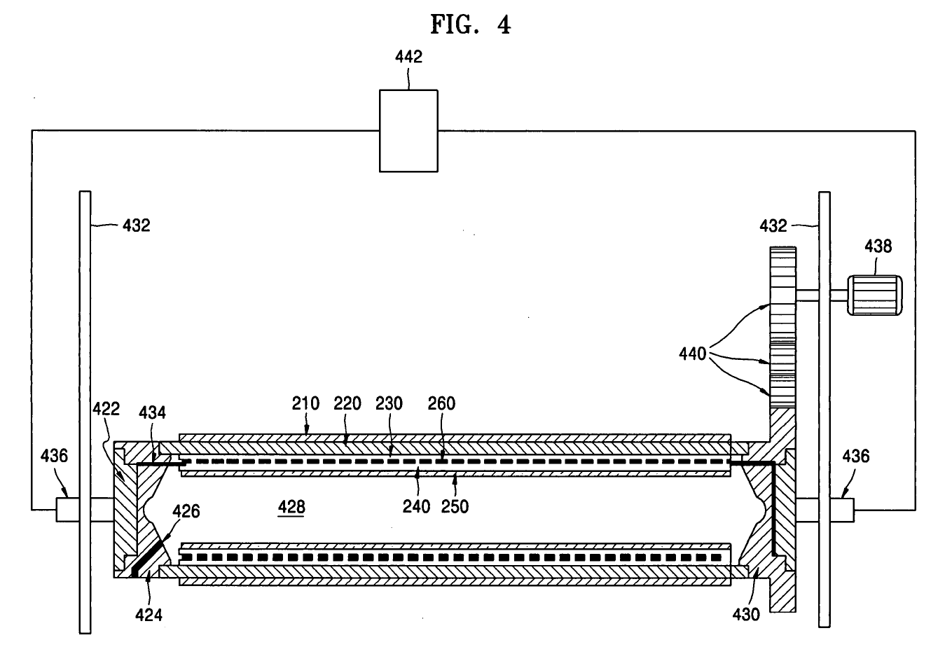

FIG. 4 is a more detailed diagram of a fusing unit according to an embodiment of the present invention. Referring to FIG. 4, the fusing unit comprises the coating portion 210, the toner fusing unit 220, the first and second insulating layers 230 and 240, the tube-expansion adhesion portion 250, the coil 260. An end cap 424 and a power transmission end cap 430 are installed at opposite ends of the toner fusing unit 220. The configuration of the power transmission end cap 430 is similar to that of the end cap 424.

However, the power transmission end cap 430 comprises a power transmission portion such as a gear 440 so that the power transmission end cap 430 is connected to a driving portion 438, which rotates the toner fusing unit 220, is installed in a frame 432 that supports the toner fusing unit 22.

In addition, an air vent 426 is formed in the end cap 424. The air vent 426 is disposed in such a manner that the end cap 424 is installed in the fusing unit, an internal space 428 of the fusing unit is well ventilated via the air vent 426. Thus, even though the tube-expansion adhesion portion 250 is heated by heat transferred from the coil 260, the internal space 428 is ventilated via the air vent 426 and thus is maintained at atmospheric pressure. Alternatively, the air vent 426 may be disposed in the power transmission end cap 430. In addition, the air vent 426 may be placed between both the end cap 424 and the power transmission end cap 430.

An electrode 422 is formed in the end cap 424 and the power transmission end cap 430, respectively. The electrode 422 is electrically connected to a lead portion 434. An AC current from an external power supply unit 442 is supplied to the coil 260 via a brush 436, the electrode 422, and the lead portion 434.

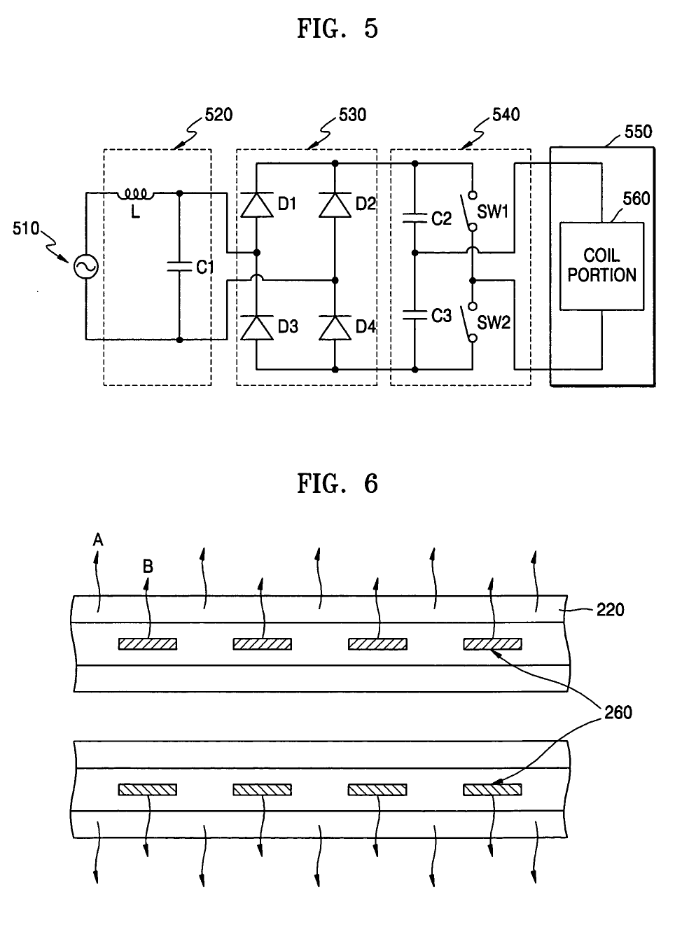

FIG. 5 is a functional block diagram of a fusing device having the fusing unit shown in FIG. 2, according to another embodiment of the present invention. Referring to FIG. 5, the fusing device of FIG. 5 comprises a power supply unit 510, a line filter 520, a rectifier 530, a high-frequency current generator 540, and a fusing unit 550 having a coil portion 560.

The power supply unit 510 supplies AC power having a predetermined amplitude and frequency. The line filter 520 that includes an inductor L1 and a capacitor C1 removes harmonic components included in the AC power received from the power supply unit 510. The line filter 520 is illustrated as one type of a line filter suitable for use with the present invention. Another type of line filter may be used as the line filter 520 without departing from the scope of the present invention.

The rectifier 530 provides a DC voltage by rectifying the AC voltage supplied by the line filter 520. The rectifier 530 is a bridge rectifier comprising four diodes D1, D2, D3, and D4 and rectifies the AC voltage into the DC voltage according to polarities of the four diodes D1, D2, D3, and D4. Another type of line rectifier may be used as the rectifier 530 without departing from the scope of the present invention.

The high-frequency current generator 540 generates an AC current from the DC voltage supplied by the rectifier 530. The high-frequency current generator 540 of FIG. 5 comprises two capacitors C2 and C3 and two switches SW1 and SW2 and converts the rectified DC voltage into the AC voltage and current by switching the switches SW1 and SW2 on and off. Another type of high-frequency current generator may be used as the high-frequency current generator 540 without departing from the scope of the present invention.

The fusing unit 550 comprises the coil portion 560, as shown in FIG. 2. The coil portion 560 is resistance-heated by the AC current generated by the high-frequency current generator 450. In addition, the coil portion 560 generates an alternating magnetic flux that changes according to a high-frequency current supplied by the high-frequency current generator 540. The changing alternating magnetic flux crosses with a toner fusing unit (not shown) of the fusing unit 550, and an eddy current is generated in the toner fusing unit in a direction in which the changed alternating magnetic flux is disturbed. The toner fusing unit has electrical resistance and thus is induction-heated by the generated eddy current.

The fusing device shown in FIG. 5 includes the high-frequency current generator 540 so as to generate an AC current to be input to the coil portion 560. However, a low-frequency current instead of a high-frequency current may be input to the coil portion 560 of the fusing device according to the application of the fusing device, and a low-frequency current generator may be provided so as to generate the low-frequency current.

FIG. 6 illustrates a heat source for heating the toner fusing unit 220 of the fusing unit of the fusing device according to another embodiment of the present invention. Referring to FIG. 6, the toner fusing unit 220 of the fusing unit of the fusing device is heated by induction-heating or resistance-heating. An alternating magnetic flux that crosses with the toner fusing unit 220 is generated according to the AC current flowing through the coil portion 260. Owing to the generated alternating magnetic flux, a predetermined eddy current is generated in the toner fusing unit 220. The generated eddy current flows through the toner fusing unit 220, which has an electrical resistance, so that heat is generated in the toner fusing unit 220. Heat generated by the eddy current is induction heat and is indicated by an arrow A shown in FIG. 6.

Since the coil 260 has electrical resistance, if a predetermined AC current is input to the coil 260, heat that corresponds to the resistance of the coil 260 is generated. Heat generated by the resistance of the coil 260 is resistance heat and is indicated by an arrow B shown in FIG. 6.

The ratio of induction heat and resistance heat in a total amount of heat of the toner fusing unit 220 can be adjusted according to the material used for the coil 260, the number of turns of the coil 260, the material used for the toner fusing unit 220, and a frequency of the AC current applied to the coil 260 without departing from the scope of the present invention. For example, in the fusing device comprising coils made of copper and the toner fusing unit 220 made of iron, when an AC input having a voltage of 220 V, a power of 1.2 kW, and a frequency of 4.5 kHz is input to the coil 260, it takes 20 seconds to heat the toner fusing unit 220 to a target fusing temperature of approximately 180° C. When an AC input having a voltage of 220 V, a power of 1.2 kW, and now a frequency of 130 kHz is input to the coil 260, it takes 12 seconds to heat the toner fusing unit 220 to the target fusing temperature of approximately 180° C.

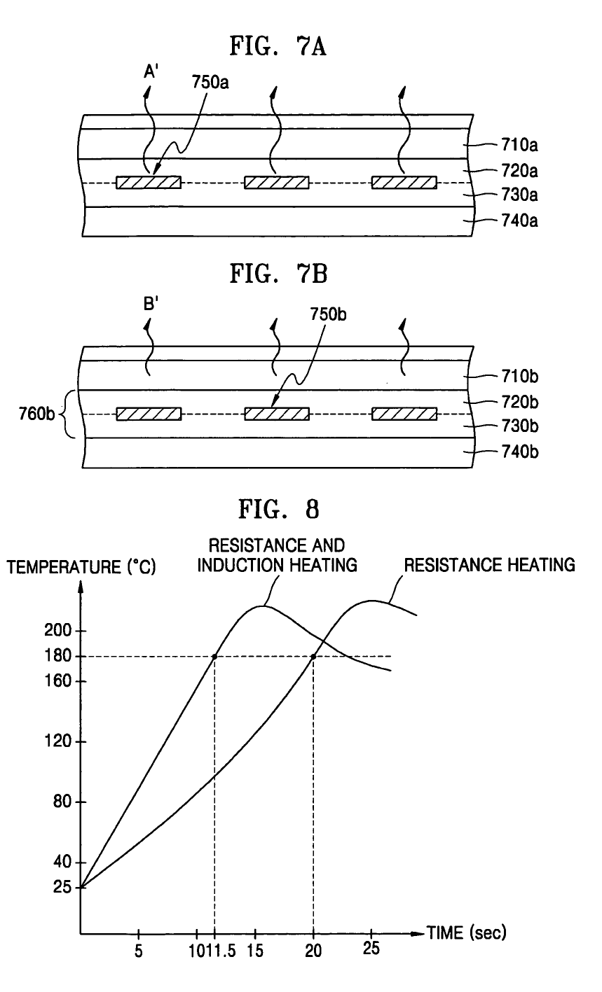

FIG. 7A is a cross-sectional view taken along a lateral plane through a fusing unit using resistance heating, and FIG. 7B is a cross-sectional view taken along a lateral plane through a fusing unit using induction heating.

As shown in FIG. 7A, when a predetermined alternating current is input to a resistance coil 750a in the fusing unit, heat corresponding to resistance of the resistance coil 750a is generated in the resistance coil 750a. Heat generated in the resistance coil 750a is transferred to a toner fusing unit 710a via insulating layers 720a and 730a having low thermal conductivity and then is used to heat the toner fusing unit 710a. Thus, a heat source of the fusing device using resistance-heating is Joule heat generated in the resistance coil 750a, and Joule heat generated in the resistance coil 750a is indicated by an arrow A shown in FIG. 7A.

As shown in FIG. 7B, when a predetermined alternating current is input to an induction coil 750b in the fusing unit, the induction coil 750b generates an alternating magnetic flux that changes according to the input alternating current. A toner fusing unit 710b is closely adhered to the induction coil 750b via an insulating layer 720b at a minimum insulation gap, and a coil portion 760b comprising the induction coil 750b and the insulating layer 720b, 730b is rotated together with the toner fusing unit 710b. An alternating magnetic flux generated in the induction coil 750b crosses with the toner fusing unit 710b, and an eddy current is generated in the toner fusing unit 710b by changes of the alternating magnetic flux that crosses with the toner fusing unit 710b. Since the toner fusing unit 710b has electrical resistance, the eddy current generated in the toner fusing unit 710b generates heat in the toner fusing unit 710b. Thus, a heat source of the toner fusing unit 710b using induction heating is Joule heat generated in the toner fusing unit 710b, and heat generated in the toner fusing unit 710b is indicated by an arrow B shown in FIG. 7B.

A target fusing temperature of the unit for fusing a toner on paper is the surface temperature of the toner fusing unit 710a or 710b. Thus, the fusing unit using induction heating in which heat generated according to electrical resistance of the toner fusing unit 710b is used to directly heat the toner fusing unit 710b has a shorter warm-up time than the fusing unit using resistance heating in which heat generated in the resistance coil 750a inside the toner fusing unit 710a is transferred to the toner fusing unit 710a via the insulating layers 720a and 730a.

FIG. 8 is a graph showing experimental data comparing times taken for heating a toner fusing unit from room temperature of 25° C. to a target fusing temperature of 180° C. in both a conventional fusing device using resistance heating and a fusing device using both resistance and induction heating according to an embodiment of the present invention. In this experiment, the diameter of the toner fusing unit is 35 mm, the thickness thereof is 0.7 mm, and a material used therefor is an iron alloy.

A resistance coil of the fusing unit using resistance heating in the experiment is made of a nickel-chromium alloy and manufactured with capacity of 1200 w and has both-end resistance corresponding to a voltage applied to the resistance coil. As shown in FIG. 8, in the fusing unit using heat generated by resistance heating in the resistance coil as a main heat source, it takes about 20 seconds to heat the toner fusing unit from room temperature of 25° C. to the target fusing temperature of 180° C.

A coil of the fusing unit using induction heating according to an embodiment of the present invention is made of copper and has capacity of 1200 w. In addition, an alternating current having a frequency of 100 kHz is input to the coil. In the fusing unit according to an embodiment of the present invention, it takes about 11.5 seconds to heat the toner fusing unit from room temperature of 25° C. to the target fusing temperature of 180° C. The toner fusing unit of the fusing unit using induction heating according to an embodiment of the present invention reaches the target fusing temperature from room temperature within a shorter time than in the toner fusing unit of the fusing unit using resistance heating.

As described above, in the fusing device according to an embodiment of the present invention, the toner fusing unit is heated by using resistance heating generated in a coil and induction heating caused by an eddy current simultaneously such that the toner fusing unit can be more quickly heated to the target fusing temperature.

In the fusing device according to an embodiment of the present invention, the coil and the toner fusing unit is closely adhered to each other in a state where the insulating layer is placed between the coil and the toner fusing unit, and the coil is rotated together with the toner fusing unit. Thus, a variable alternating magnetic flux generated in the coil crosses into the toner fusing unit to a maximum extent. As a result, the efficiency of induction heating increases and the toner fusing unit can be heated up to the target fusing temperature within a short time.

Furthermore, the fusing device according to embodiments of the present invention, the coil and the toner fusing unit is closely adhered to each other in the state where the insulating layer is placed between the coil and the toner fusing unit, and a high-frequency current is input to the coil. Thus, since a variable alternating magnetic flux generated in the coil crosses into the toner fusing unit to a maximum extent and a high-frequency current is input to the coil, a stronger eddy current is generated in the toner fusing unit. As a result, the toner fusing unit can be heated to the target fusing temperature within a shorter time.

While this invention has been particularly shown and described with reference to exemplary embodiments thereof, it will be understood by those skilled in the art that various changes in form and details may be made therein without departing from the spirit and scope of the invention as defined by the appended claims.

1. A unit for fusing a toner on paper, the unit comprising:
a coil portion that is resistance-heated by a predetermined alternating current and generates an alternating magnetic flux caused by the predetermined alternating current; and
a toner fusing unit that is induction-heated by an eddy current generated by the alternating magnetic flux.

2. The unit of claim 1, wherein the coil portion comprises:
a coil that is resistance-heated by receiving the alternating current, which also generates an alternating magnetic flux; and
an insulating layer for insulating the coil and the toner fusing unit from each other.

3. The unit of claim 2, wherein the ratio of resistance heat generated in the coil and induction heat generated in the toner fusing unit is determined by at least one of a material used for the coil, a frequency of the alternating current, and a material used for the toner fusing unit.

4. The unit of claim 3, wherein the toner fusing unit is formed of at least one of a copper alloy, an aluminum alloy, a nickel alloy, an iron alloy, a chromium alloy, and a magnesium alloy.

5. The unit of claim 3, wherein the coil is formed of a copper alloy.

6. The unit of claim 3, wherein the alternating current is a high-frequency alternating current.

7. The unit of claim 2, wherein the coil portion is closely adhered to the toner fusing unit.

8. The unit of claim 7, further comprising an adhesion portion disposed inside the toner fusing unit and closely adhered to a heating body facing the toner fusing unit.

9. The unit of claim 8, wherein the adhesion portion is a tube-expansion adhesion portion closely adhering the coil portion to the toner fusing unit using a predetermined tube-expansion pressure.

10. The unit of claim 2, wherein a withstand voltage of the insulating layer is between 3 kV and 6 kV.

11. A unit for fusing a toner on paper, the unit comprising:
a coil portion that is resistance-heated by a predetermined alternating current and generating an alternating magnetic flux by the predetermined alternating current; and
a fusing roller that is induction-heated by an eddy current generated by the alternating magnetic flux.

12. The unit of claim 11, wherein the coil portion comprises:
a coil that is resistance-heated by receiving the predetermined alternating current and generates an alternating magnetic flux caused by the predetermined alternating current; and
an insulating layer for insulating the coil and the fusing roller from each other.

13. The unit of claim 12, wherein the ratio of resistance heat generated in the coil and induction heat generated in the fusing roller is determined by at least one of a material used for the coil, a frequency of the alternating current, and a material used for the fusing roller.

14. The unit of claim 13, wherein the fusing roller is formed of at least one of a copper alloy, an aluminum alloy, a nickel alloy, an iron alloy, a chromium alloy, and a magnesium alloy.

15. The unit of claim 13, wherein the coil is formed of a copper alloy.

16. The unit of claim 13, wherein the alternating current is a high-frequency alternating current.

17. The unit of claim 12, wherein the coil portion is closely adhered to the fusing roller.

18. The unit of claim 17, further comprising an adhesion portion disposed inside the fusing roller and closely adhered to a heating body facing the fusing roller.

19. The unit of claim 18, wherein the adhesion portion is a tube-expansion adhesion portion closely adhering the coil portion to the fusing roller using a predetermined tube-expansion pressure.

20. The unit of claim 17, wherein the fusing roller is closely adhered to the coil portion and is rotated together with the coil portion.

21. The unit of claim 12, wherein a withstand voltage of the insulating layer is between 3 kV and 6 kV.

22. A unit for fusing a toner on paper, the unit comprising:
a coil portion for generating an alternating magnetic flux by a predetermined alternating current;
a toner fusing unit that is induction-heated an eddy current generated by the alternating magnetic flux; and
an adhesion portion disposed inside the toner fusing unit and closely adhered to a heating body facing the toner fusing unit.

23. The unit of claim 22, wherein the coil portion comprises:
a coil for generating a variable alternating magnetic flux by receiving the predetermined alternating current; and
an insulating layer for insulating the coil and the toner fusing unit from each other.

24. The unit of claim 23, wherein the predetermined alternating current is a high-frequency alternating current input to the coil.

25. The unit of claim 23, wherein the toner fusing unit is formed of at least one of a copper alloy, an aluminum alloy, a nickel alloy, an iron alloy, a chromium alloy, and a magnesium alloy.

26. The unit of claim 23, wherein the coil is formed of a copper alloy.

27. The unit of claim 23, wherein a withstand voltage of the insulating layer is between 3 kV and 6 kV.

28. A unit for fusing a toner image on paper, the unit comprising:
a coil portion for generating an alternating magnetic flux by a predetermined alternating current;
a fusing roller for generating an eddy current caused by the alternating magnetic flux and that is induction-heated by the generated eddy current; and
an adhesion portion disposed in the fusing roller and closely adhered to a heating body while facing the fusing roller.

29. The unit of claim 28, wherein the coil portion is closely adhered to the fusing roller and the adhesion portion and is rotated together with the fusing roller and the adhesion portion.

30. The unit of claim 28, wherein the coil portion comprises:
a coil for generating a variable alternating magnetic flux by receiving the predetermined alternating current; and
an insulating layer for insulating the coil and the fusing roller from each other.

31. The unit of claim 30, wherein the coil portion is closely adhered to the fusing roller and rotated together with the fusing roller.

32. The unit of claim 30, wherein the predetermined alternating current is a high-frequency alternating current input to the coil.

33. The unit of claim 30, wherein the fusing roller is formed of at least one of a copper alloy, an aluminum alloy, a nickel alloy, an iron alloy, a chromium alloy, and a magnesium alloy.

34. The unit of claim 30, wherein the coil is formed of a copper alloy.

35. The unit of claim 30, wherein a withstand voltage of the insulating layer is between 3 kV and 6 kV.

36. A device for fusing a toner on paper, the device comprising:
an alternating current generator for generating a predetermined alternating current;
a coil portion that resistance-heated by the alternating current and generates an alternating magnetic flux by the alternating current; and
a toner fusing unit that is induction-heated by an eddy current generated by the alternating magnetic flux.

37. The device of claim 36, wherein the coil portion comprises:
a coil resistance-heated by receiving the alternating current and generating a variable alternating magnetic flux caused by the alternating current; and
an insulating layer for insulating the coil and the toner fusing unit from each other.

38. The device of claim 37, wherein the ratio of resistance heating generated in the coil generating the toner fusing unit and induction heating generated in the toner fusing unit is determined by at least one of a material used for the coil, a frequency of the alternating current, and a material used for the toner fusing unit.

39. The device of claim 38, wherein the toner fusing unit is formed at least of one of a copper alloy, an aluminum alloy, a nickel alloy, an iron alloy, a chromium alloy, and a magnesium alloy.

40. The device of claim 38, wherein the coil is formed of a copper alloy.

41. The device of claim 38, wherein the alternating current generator generates a high-frequency alternating current.

42. The device of claim 37, wherein the coil portion is closely adhered to the toner fusing unit.

43. The device of claim 42, further comprising an adhesion portion disposed inside the toner fusing unit and closely adhered to a heating body with facing the toner fusing unit.

44. The device of claim 43, wherein the adhesion portion is a tube-expansion adhesion portion closely adhering the coil portion to the toner fusing unit using a predetermined tube-expansion pressure.

45. The device of claim 37, wherein a withstand voltage of the insulating layer is between 3 kV and 6 kV.

46. A method of heating a unit for fusing a toner on paper, comprising the steps of:
enclosing a coil portion within a toner fusing unit, which is further enclosed by a protective layer;
supplying an alternating current to the coil portion to generate resistance heat, wherein the alternating current generates an alternating magnetic flux;
allowing eddy currents to be formed in the toner fusing unit, which generates induction heat; and
heating the protective layer by allowing the resistance heat and induction heat to radiate to the exterior surface of the protective layer.
